(19) United States
(12) Patent Application Publication
(10) Pub. No.: US 2008/0222017 A1
(43) Pub. Date: Sep. 11, 2008

(54) Method of structuring a property transaction enabling the seller to reacquire the property and maximize profits on the property

(76) Inventors: Ganesan Visvabharathy, Burr Ridge, IL (US); Michael Collins, Long Grove, IL (US)

Correspondence Address: IPHORGAN, LTD., 1130 LAKE COOK ROAD, SUITE 240, BUFFALO GROVE, IL, 60089, US

(21) Appl. No.: 12/012,006

(22) Filed: Jan. 29, 2008

Related U.S. Application Data
(60) Provisional application No. 60/898,056, filed on Jan. 29, 2007.

(51) Int. Cl. G06Q 40/00; G06Q 30/00

(52) U.S. Cl. 705/35; 705/1

(57) ABSTRACT

The present invention relates to methods of structuring contracts for the purchase of property, and specifically relates to a method of structuring a contract for the purchase of real property, such as a parcel of real estate, enabling the original seller to reacquire the sold property in a transaction controlled by the seller and providing the original purchaser with additional capital to purchase the real property. The method comprises

### PRIORITY INFORMATION

This application claims priority to provisional patent application Ser. No. 60/898,056 filed on Jan. 29, 2007.

### FIELD OF INVENTION

The present invention relates to methods of structuring contracts for the purchase of property, and specifically relates to a method of structuring a contract for the purchase of real property, such as a parcel of real estate, enabling the original seller to reacquire the sold property in a transaction controlled by the seller and providing the original purchaser with additional capital to purchase the real property.

### BACKGROUND OF INVENTION

This application claims priority to provisional patent application Ser. No. 60/898,056 filed on Jan. 29, 2007, the disclosure of which is expressly incorporated herein by reference. Real estate markets have a history of property value upswings and downswings, often times resulting in significant windfall profits or potential and unrealized profits for the current owner of the property. Often times property developers have to offer the first units in a project for sale at discounted prices or prices that ultimately are below the market value of the property to secure appropriate financing to move forward with or complete the project. Both situations result in the developer losing out on the opportunity to collect significantly higher profits on the sale of the property once the market value of the property has been established. For example, a real estate developer may sell a property at a price of $300,000 in December, 2006. An upswing in the market results in the value of the property being $400,000 in July, 2007, resulting in a $100,000 of lost profit to the developer.

Even once the market value is established, the developer still faces challenges to maximizing profits on the sales of units remaining in the developer's inventory. Buyers who purchase units prior to establishment of the true market value of the property often times make the purchase with the intent of “flipping” the unit by selling it for a token amount of profit without ever occupying the unit. For example, the purchaser purchased the unit for $400,000 in January, 2007, and then ‘flips’ the unit for a price of $450,000 (at or below the market value) in November, 2007, netting a profit of $50,000. At the same time, the ‘flipper’ is offering a unit for sale, the developer may be trying to get a target price of, for example, $475,000, on units remaining in the developer's inventory. The developer's target price will be impossible to obtain as long as the flipper's unit is on the market. The flipper's asking price will also drive down the market value destroying the developer's pricing matrix and affecting the developer's ability to obtain the target price even after the flipper's unit is off the market.

Currently available options for enabling a developer to reacquire previously sold units or units under contract when fluctuations in market value would provide greater profits to the developer are limited to contractual provisions providing the developer with a right of first refusal to repurchase a unit or rescinding or breaking a contract to sell the unit. The drawback of a “right of first refusal” provision is that the developer is not in control of any aspect of the re-acquisition transaction. The timeframe of the transaction is dictated by the seller and may occur at a time when the developer is not in a position to repurchase, e.g. the developer has a significant inventory of units or is not in position to secure the financing or cash required to purchase the unit at that time. Additionally, the purchase price will be driven by the seller and the seller's perceived ability to sell the property to a buyer other than the developer. Rescinding or breaking a contract can have adverse legal consequences.

Accordingly, one objective of the present inventive method of structuring a real estate transaction is to enable the developer to maximize the number of units available in the developer's inventory for sale at a maximum profit potential.

In addition to the real estate pitfalls described herein, the buyer in a real estate transaction is faced with significant costs in addition to the purchase price of the property. For a variety of reasons, very seldom will a buyer complete the transaction with an outright cash payment to the seller. Accordingly, the buyer will opt to seek some level of financing for the purchase. The costs of securing financing and closing on the transaction can sometimes be significant, requiring the buyer to come up with thousands of extra dollars simply to complete the deal. Accordingly, it is another objective of the present invention to provide a method of structuring a real estate transaction to provide the buyer with an additional source of capital to complete the transaction.

### BRIEF DESCRIPTION OF DRAWINGS

FIG. 1 shows a flow chart of the steps of the present inventive method;

FIGS. 2-7 shows a sample contract representing the terms of a real estate transaction pursuant to the present inventive method.

### DETAILED DESCRIPTION OF INVENTION

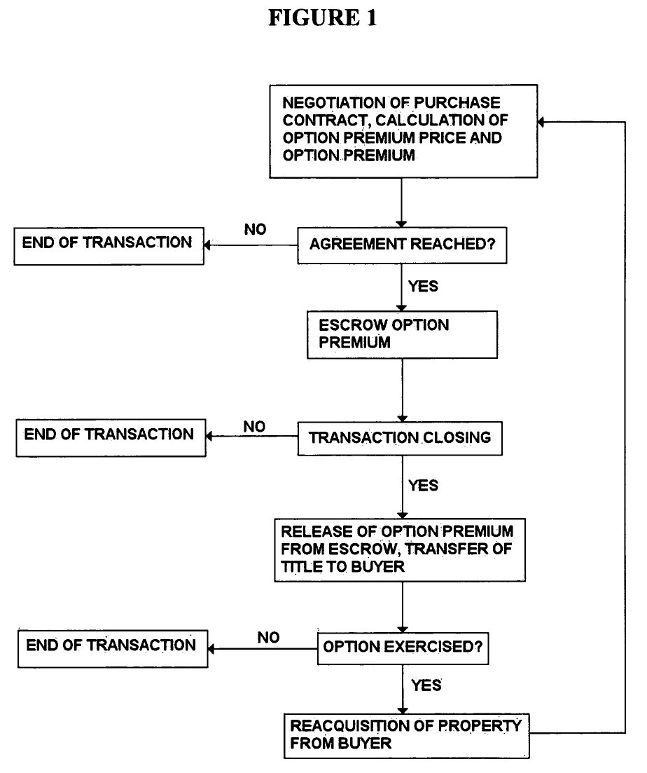

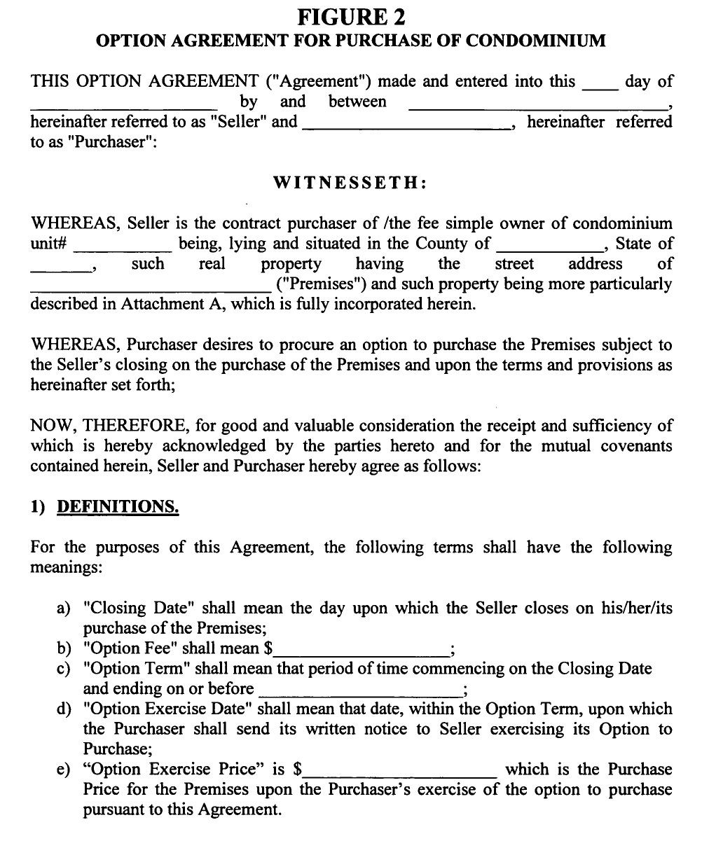

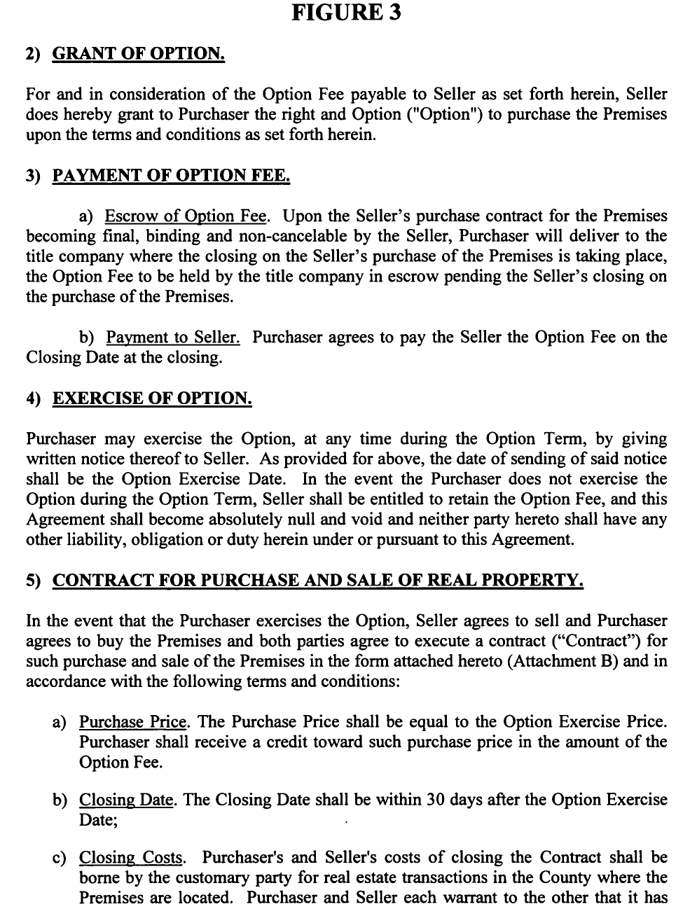

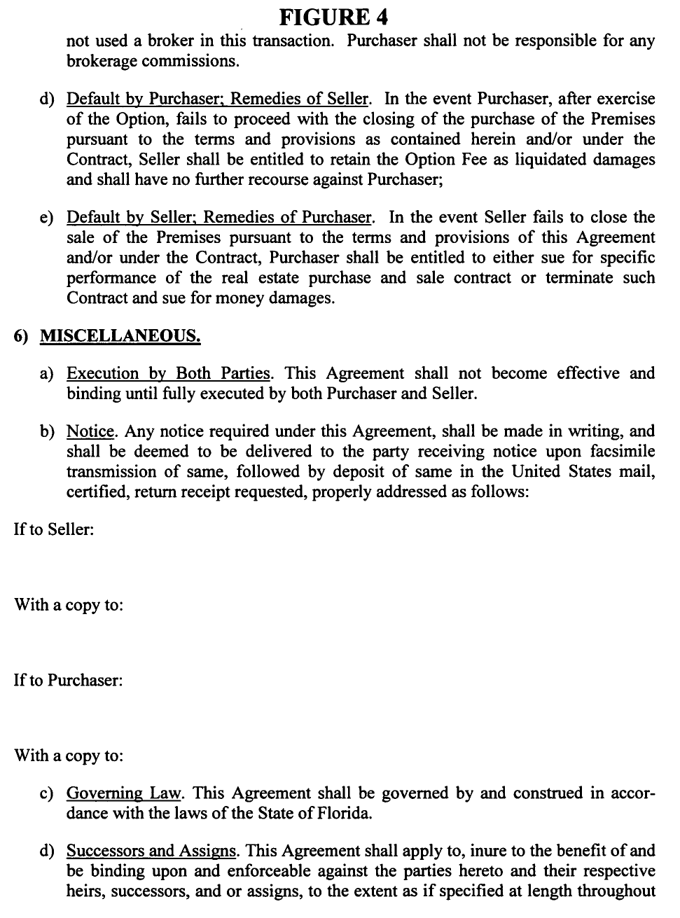

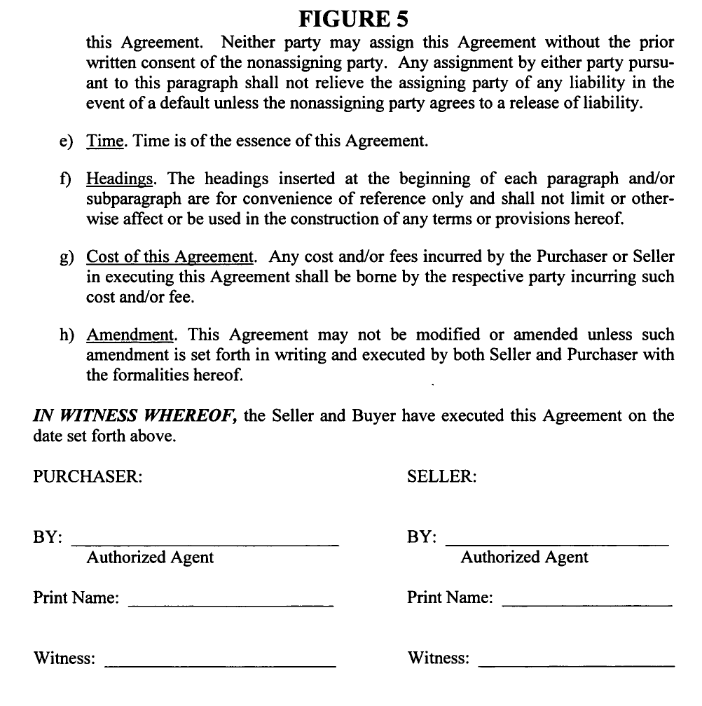

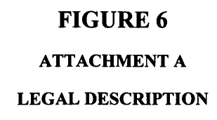

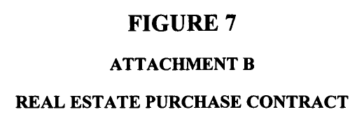

FIG. 1 shows the steps of a method of structuring a real estate transaction that enables a seller of property, such as a real estate developer to re-acquire a previously sold property in a transaction completely controlled by the developer in terms of the timeframe in which the transaction occurs and the financial constraints of the transaction. FIGS. 2-7 show an example of a contract structured in accordance with the method disclosed in FIG. 1. Within the purchase contract selling the property from the developer to the buyer is an option for repurchase of the property by the developer. In this manner, the option is structured to enable the developer to determine the timeframe for execution and cost of repurchase of the property (the “option exercise price”). The present inventive method contemplates the developer paying the buyer an “option premium” into an escrow account at the time of execution of the purchase agreement with the buyer, to be released to the buyer at closing of the sale of the property.

Option agreements at a fixed price are not common in real estate transactions-usually, there are no option agreements; if at all there are any, they provide for the right to repurchase for a certain period of time (say, one year), in the form of ‘right of first refusal’, whereby the price is left open, to be determined later, depending on whether or not an offer to purchase the unit is received from a new buyer (market conditions will determine the price at that time, if such an offer is ever received). In these situations, an option premium is never paid for this right and an option exercise price is not established at the time of the original purchase by the buyer.

The present inventive methodology eliminates all uncertainties at the time of purchase itself by prescribing the option price, time period to exercise the option, and an option exercise price. If the option is exercised, both the developer and buyer come out ahead, as the buyer gets the amount of the option premium, plus the ability to make a fixed profit on the sale of the property back to the developer, whereas the developer gets the ability to lock in a price (at a time of rising prices), and increase profit margin. The present inventive method has the added advantage of preventing market value distortion and unruly speculation resulting from the activities of flippers.

As previously discussed, the option premium can be paid to the buyer, once the buyer has executed the purchase contract. Of course, the option premium should be fully refundable to the developer, if the purchaser does not close on the sale of the property. But, once the premium has been paid, and the buyer decides to go ahead with the purchase, the buyer can use the option premium payment to fund the down payment on the property and/or cover the closing costs, essentially securing 100% financing on the purchase of the property. It is possible that in some cases, the option exercise price may be equal to or even larger than the down payment required for the buyer to obtain a mortgage. Thus, in some cases, the buyer can walk away with money in his/her pocket after closing, instead of being out of pocket just to handle the closing. Accordingly, the present inventive method offers benefits to the prospective buyer seeking to finance the purchase of the property.

An important component to the present inventive method is the calculation of the appropriate amount of the option premium. It is contemplated that one method for establishing the option premium value is to establish a multiplier by calculating a value representing property value appreciation over a specified period of time, then taking a percentage of the property price multiplied by the multiplier. A percentage of the option premium value is used to establish the value of the option premium. It is contemplated that the present inventive method will establish the property value appreciation multiplier over a period of ten (10) years immediately preceding the purchase date to establish an appreciated value of the subject property. The option exercise price is calculated as 80% of the appreciated value and the option premium is 10% of the option exercise price. These percentages and timeframes are exemplary in nature and should not be considered as limiting. The percentages and timeframe may be modified as needed to adapt to the specific circumstances of a particular transaction or series of events.

It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

We claim:

1. A method of structuring a real estate transaction to enable a seller of a subject property an option to repurchase the subject property from a buyer within a time period, at an option exercise price.

2. The method of claim 1 further comprising determining the option exercise price by first calculating an appreciated value of the subject property and then calculating the option exercise price with a first multiplier.

3. The method of claim 2 wherein the appreciated value of the subject property is calculated over a period of ten years, commencing the year of the transaction and moving backward therefrom.

4. The method of claim 2 wherein the first multiplier used to calculate the option exercise price is 0.8.

5. The method of claim 2 further comprising the step calculating an option premium from the option exercise price and a second multiplier.

6. The method of claim 5 wherein the second multiplier is 0.1.

7. A method of structuring a real estate transaction to enable a buyer of a subject property to capture a first portion of the appreciated value of the subject property at the time of the sale of the subject property to the buyer.

8. The method of claim 7 further comprising determining the option exercise price by first calculating an appreciated value of the subject property and then calculating the option exercise price with a first multiplier.

9. The method of claim 7 wherein the appreciated value of the subject property is calculated over a period of ten years, commencing the year of the transaction and moving backward therefrom.

10. The method of claim 8 wherein the first multiplier used to calculate the option exercise price is 0.8.

11. The method of claim 8 further comprising the step calculating an option premium from the option exercise price and a second multiplier.

12. The method of claim 11 wherein the second multiplier is 0.1.
